(19) United States
(12) Patent Application Publication
(10) Pub. No.: US 2004/0105366 A1
(43) Pub. Date: Jun. 3, 2004

(54) Information storage medium, and data recording, reproducing, detecting and/or evaluating apparatus and method using the same

(75) Inventors: Jae-seong Shim, Seoul (KR); In-sik Park, Gyeonggi-do (KR); Kyung-geun Lee, Gyeonggi-do (KR); Byung-in Ma, Gyeonggi-do (KR); Jin-han Kim, Gyeonggi-do (KR); Kiu-hae Jung, Gyeonggi-do (KR); Hyun-soo Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/637,708

(22) Filed: Aug. 11, 2003

(30) Foreign Application Priority Data
Sep. 11, 2002 (KR) 2002-55135
Sep. 12, 2002 (KR) 2002-55482

(51) Int. Cl. G11B 7/0045; G11B 7/24

(52) U.S. Cl. 369/47.28; 369/275.3; 369/59.11

(57) ABSTRACT

A data recording, reproducing, detecting and/or evaluating apparatus includes a modulator which modulates input information data by a predetermined modulation method, according to a first clock signal having a basic clock period (T) for recording/reproducing data, and a bit expander which expands bits for a modulated bitstream according to a second clock signal that are a predetermined multiple of the first clock signal. By forming pits with an nT length and not forming pits with an (n±1)T length on the information storage medium, stable reproduction of data is enabled.

### CROSS-REFERENCE TO RELATED APPLICATIONS

This application claims the benefit of Korean Patent Application No. 2002-55135, filed on Sep. 11, 2002 in the Korean Intellectual Property Office and Korean Patent Application No. 2002-55482, filed on Sep. 12, 2002 in the Korean Intellectual Property Office, the contents of which are incorporated herein by reference in their entirety.

### BACKGROUND OF THE INVENTION

1. Field of the Invention

The present invention relates to an information storage medium and a data recording, reproducing, detecting and/or evaluating apparatus, and a method using the same, and more particularly, to an information storage medium on which data in an area where information data is stored and/or data in an area other than a user information data area are formed as pits each with an nT length, and a data recording, reproducing, detecting and/or evaluating apparatus and method using the same.

2. Description of the Related Art

In general, an optical disc is widely used as an information storage medium on which information is recorded and/or reproduced by an optical pickup unit which does not contact the storage medium. The types of optical disc are broadly broken down into a compact disc (CD) and a digital versatile disc (DVD) according to the information storage capacity. Optical discs on which data can be recorded, deleted, and reproduced include a 650 megabytes (MB) CD-recordable (R), CD-Rewritable (RW) and a 4.7 gigabytes (GB) DVD+RW, and reproduction-only optical discs include a 6.5MB CD and a 4.7GB DVD-read only memory (ROM). Furthermore, a high density (HD)-DVD having a capacity of 23GB or more has been under development.

In the optical discs that have been widely used up to date (i.e., in CDs and DVDs), an eight fourteen modulation (EFM) method and an eight fourteen modulation plus (EFM+) method are used respectively. These methods use run length limited (RLL) (d, k) modulation satisfying a minimum constraint (d) and a maximum constraint (k). More specifically, an RLL(2, 10) modulation method is used and with a minimum pit length of 3T (T being equivalent to a basic clock period or a channel clock period when data are recorded or reproduced), pits with lengths of 4T, 5T, . . . , are formed on a disc. As another modulation method, there is an RLL(1,7) modulation method which was used in other discs, such as a magneto optical disc drive (MODD). In the method, with a minimum pit length of 2T, pits with lengths of 3T, 4T, . . . , 8T, are formed on a disc.

FIG. 1 is a histogram of pits when with a minimum pit length of 2T, the pits with lengths of 3T, 4T, . . . , are formed on the disc by the related art RLL(1,7) modulation. The related art data evaluating apparatus which detects or evaluates the pits formed on the disc as shown in FIG. 1 is shown in FIG. 2.

Referring to FIG. 2, an optical detector 21 converts an optical signal, which is reflected from a disc, into an electrical signal. Here, as an example, it is assumed that the optical detector 21 is divided into four parts and the top left detection part, the top right detection part, the bottom right detection part, and the bottom left detection part are referred to as A, B, C, and D, respectively. A pre-amplifier 22 adds up electrical signals from all optical detecting parts (A, B, C, D) and provides a sum signal (A+B+C+D), which will be referred to as a radio frequency (RF) signal. A DC offset remover 23 removes the DC offset of the RF signal output from the pre-amplifier 22. The RF signal which passes through the DC offset remover 23 is boosted in an equalizer 24, high frequency noise of the RF signal is reduced through a low pass filter (LPF) 25, and the analog RF signal is binarized through a slicer 26. A reproduction clock signal, which is synchronized with the binarized RF signal, is generated by using a phase locked loop circuit 27. An evaluator 28 may comprise a jitter analyzer or a timing interval analyzer (TIA), and measures jitter by receiving the binarized RF signal provided by the slicer 26 and the reproduction clock signal generated in the PLL circuit 27, or evaluates the quality of a reproduced signal by analyzing the histogram of the binarized RF signal by using the TIA.

FIG. 3 is the actual histogram of pits detected by the TIA in the evaluator 28 shown in FIG. 2. Specifically, FIG. 3 shows the histogram of a reproduced signal when pits are formed on an optical disc in which the ordinary RLL(1,7) is used, pits and spaces have lengths between 2T and 8T, and a synchronization pattern is formed by using pits and spaces with 9T lengths that are outside the scope of the lengths of data (2T-8T). The overlapping part centering around each T is a part where an error occurs. In the figure, when the dotted lines are taken as a basis, the part where two histograms overlap is a part where another neighbor T begins before a current T ends (i.e., a part where an error occurs). On an optical disc, pits or spaces are generally formed with T intervals within a limited run length scope and accordingly, in an overlapping part as shown in the histograms of FIG. 3, errors occur.

### SUMMARY OF THE INVENTION

The present invention provides an information storage medium on which information data are formed as pits with an nT length and not formed as pits with (n±1)T length, and a data recording, reproducing, detecting and/or evaluating apparatus and method using the same.

The present invention also provides an information storage medium on which data in an area other than a user information data area are formed as pits each with an nT length, and not formed as pits with (n±1)T length, and a data recording, reproducing, detecting and/or evaluating apparatus and method using the same.

The present invention also provides an information storage medium on which information data are modulated by different modulation methods according to areas and recorded, and a data recording, reproducing, detecting and/or evaluating apparatus and method using the same.

The present invention also provides an information storage medium on which information data in a user area are recorded by using an RLL(d,k) modulation method and information data in an additional information area are recorded by using a bi-phase modulation method, and a data recording, reproducing, detecting and/or evaluating apparatus and method using the same.

The present invention also provides an information storage medium on which information data are recorded by using only parts of pits or spaces in a user area, in an additional information area, and a data recording, reproducing, detecting and/or evaluating apparatus and method using the same.

Additional aspects and/or advantages of the invention will be set forth in part in the description which follows and, in part, will be obvious from the description, or may be learned by practice of the invention.

According to an aspect of the present invention, an information storage medium stores information data modulated by a predetermined modulation method, bit expansion is performed for the modulated bitstream, and the expanded bitstream is recorded on the information storage medium on which the information data are formed as pits with an nT length and not formed as pits with an (n±1)T length where the T is the cycle of a basic clock signal for recording or reproducing data and n is an integer.

According to another aspect of the present invention, an information storage medium includes a first area which stores data modulated by a first modulation method; and a second area which stores data modulated by a second modulation method, wherein the data modulated by the second modulation method are stored by using only parts of pits or spaces formed on the storage medium by the first modulation method.

According to still another aspect of the present invention, a data recording apparatus which records information data on an information storage medium includes a modulation unit which modulates input information data, by a predetermined modulation method according to a first clock signal having a basic clock period (T) for recording or reproducing data; and a bit expander which, in order to form a modulated bitstream that is output from the modulation unit as pits with an nT length (n is an integer), expands bits according to a second clock signal which is a predetermined multiple of the first clock signal.

According to yet still another aspect of the present invention, a data recording apparatus, which records information data on an information storage medium having at least a first area and a second area, includes a first modulation unit which modulates input information data according to a first modulation method; a second modulation unit which modulates the input information data according to a second modulation method; and a recording unit which records the data modulated by the first modulation unit in the first area and records the data modulated by the second modulation unit in the second area, wherein the data modulated by the second modulation method use only parts of pits or spaces formed on the information storage medium by the first modulation method.

According to a further aspect of the present invention, a data reproducing apparatus, which reproduces data stored on an information storage medium, includes a clock generation unit which generates a first clock signal synchronized with a reproduction signal which is reproduced from the information storage medium and generates a second clock signal obtained by reducing the first clock signal with a predetermined number; and a restoration unit which provides restored information data by restoring the reproduction signal by a demodulation method corresponding to a modulation method used in recording the signal, according to the second clock signal.

According to an additional aspect of the present invention, a data reproduction apparatus, which reproduces data stored on an information storage medium having at least a first area storing data modulated by a first modulation method and a second area storing data modulated by a second modulation method, includes a binarizing unit which binarizes a reproduction signal read from the information storage medium and provides the binarized reproduction signal; a clock generation unit which generates a reproduction clock signal from the binarized reproduction signal and generates a clock signal obtained by reducing the reproduction clock signal with a predetermined number; a first restoration unit which restores the binarized reproduction signal by a method corresponding to the first modulation method, according to the reproduction clock signal; and a second restoration unit which restores the binarized reproduction signal by a second demodulation method corresponding to the second modulation method, according to the reduced clock signal.

According to also an aspect of the present invention, a data detection apparatus, which detects data on an information storage medium on which are stored information data with an nT length (T denotes the cycle of a basic clock signal for recording or reproducing data and n is an integer), includes a converting unit which converts an optical signal read from the information storage medium into an electrical signal and provides the resulting signal as a converted reproduction signal; a binarizing unit which binarizes the reproduction signal and provides a binarized signal; and a correction unit which corrects a run length of the binarized signal.

According to another aspect of the present invention, a data evaluating apparatus, which detects data on an information storage medium on which are stored information data with an nT length (T denotes the cycle of a basic clock signal for recording or reproducing data and n is an integer) and evaluates the data, includes a converting unit which converts an optical signal read from the information storage medium into an electrical signal and provides the resulting signal as a reproduction signal; a binarizing unit which binarizes the reproduction signal and provides a binarized signal; a correction unit which corrects a run length of the binarized signal; and an error rate detection unit which counts an error rate for the output of the correction unit and evaluates the performance of the data detection.

According to another aspect of the present invention, a data recording method by which information data are recorded on an information storage medium includes modulating input information data by a predetermined modulation method according to a first clock signal having a basic clock period (T) for recording or reproducing data and providing a modulated bitstream; and providing an expanded bitstream by bit expanding the modulated bitstream according to a second clock signal which is a predetermined multiple of the first clock signal in order to form the modulated bitstream as pits with an nT length (n is an integer).

According to another aspect of the present invention, a data recording method by which information data are recorded on an information storage medium having at least a first area and a second area includes modulating input information data according to a first modulation method; modulating input information data according to a second modulation method; and recording the data modulated by the first modulation method in the first area and recording the data modulated by the second modulation method in the second area, wherein the data modulated by the second modulation method use only parts of pits or spaces formed on the information storage medium by the first modulation method.

According to another aspect of the present invention, a data reproducing method of reproducing information data stored on an information storage medium includes generating a first clock signal synchronized with a reproduction signal which is reproduced from the information storage medium and generating a second clock signal obtained by reducing the first clock signal with a predetermined number; and providing restored information data by restoring the reproduction signal according to the second clock signal by a demodulation method corresponding to a modulation method used when the reproduction is recorded.

According to another aspect of the present invention, a data reproduction method of reproducing information data stored on an information storage medium, which has at least a first area storing data modulated by a first modulation method and a second area storing data modulated by a second modulation method, includes binarizing a reproduction signal read from the information storage medium and providing a binarized reproduction signal; restoring the binarized reproduction signal according to a reproduction clock signal by a first demodulation method corresponding to the first modulation method; and restoring the binarized reproduction signal according to a clock signal obtained by reducing the reproduction clock signal to 1/N, by a second demodulation method corresponding to the second modulation method.

According to another aspect of the present invention, a data detection method of detecting information data on an information storage medium on which are stored information data with an nT length (T denotes the cycle of a basic clock signal for recording or reproducing data and n is an integer) includes binarizing a reproduction signal reproduced from the information storage medium and providing a binarized signal; and correcting a run length of the binarized signal.

According to another aspect of the present invention, a data evaluating method of detecting and evaluating information data on an information storage medium on which are stored information data with an nT length (T denotes the cycle of a basic clock signal for recording or reproducing data and n is an integer) includes binarizing a reproduction signal reproduced from the information storage medium and providing a binarized signal; correcting the run length of the binarized signal and providing a corrected signal; and counting an error rate of the corrected signal and evaluating the performance of data detection.

### BRIEF DESCRIPTION OF THE DRAWINGS

The above aspects and/or advantages of the present invention will become more apparent and more readily appreciated by describing in detail embodiments thereof with reference to the accompanying drawings in which:

FIG. 1 is a histogram of pits formed on a disc according to the related art;

FIG. 2 is a block diagram of the related art data evaluating apparatus which detects and/or evaluates pits formed on the disc shown in FIG. 1;

FIG. 3 is a histogram of pits detected by the evaluating apparatus shown in FIG. 2;

FIG. 4 is a diagram showing the layout of an information storage medium according to an embodiment of the present invention;

FIG. 5 is a histogram of a signal reproduced from an additional information area of the information storage medium shown in FIG. 4;

FIG. 6 is a block diagram of an embodiment of a data recording apparatus according to the present invention;

FIG. 7 is a block diagram of an embodiment of a data reproducing apparatus according to the present invention;

FIG. 8 is a block diagram of another embodiment of a data recording apparatus according to the present invention;

FIG. 9 is a histogram of data information (pits) recorded by the recording apparatus shown in FIG. 8;

FIG. 10 is a block diagram of another embodiment of a data reproducing apparatus according to the present invention;

FIGS. 11A through 11K are timing diagrams showing a data recording/reproducing process according to an embodiment of the present invention;

FIG. 12 is a block diagram of an embodiment of a data evaluating apparatus;

FIG. 13 is a histogram of pits observed by the data evaluating apparatus shown in FIG. 8 when the pits are formed on an information storage medium as shown in FIG. 9;

FIG. 14 is a reference diagram for explaining the operation principle of a run length corrector shown in FIG. 12;

FIG. 15 is a histogram of a binarized RF signal before the signal passes through the run length corrector shown in FIG. 12;

FIG. 16 is a histogram of an RF signal corrected by the run length corrector shown in FIG. 12;

FIG. 17 is a block diagram of another embodiment of a data evaluating apparatus according to an embodiment of the present invention;

FIG. 18 is a block diagram of an embodiment of a data detection apparatus according to the present invention;

FIG. 19 is a block diagram of another embodiment of a data detection apparatus according to the present invention; and

FIG. 20 is a block diagram of still another embodiment of a data detection apparatus according to the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An example in which information data in a user data information area and information data in an additional information area are recorded by using a different modulation method, and pits with an nT length are formed in the additional information area and pits with an (n±1)T length are not formed in the additional information area, will now be explained with reference to FIG. 4.

FIG. 4 is a diagram showing the layout of an information storage medium according to an embodiment of the present invention. The information storage medium has a user data information area (hereinafter referred to as a “user area”) and the remaining area (hereinafter referred to as an “additional information area”). On the information storage medium, there are at least one or more additional information areas and at least one or more user areas. Though the additional information area precedes the user area in FIG. 4, the locations and the number of areas are not fixed. The additional information area may include information such as copyright protection related information, disc manufacturer related information, contents provider related information, contents right related information, contents specification related information, and additional information for correcting errors in data in a user area. This additional information area may be referred to as a data link block, a run in/out area, etc., according to the disc type.

In the user area on the information storage medium, the RLL(d,k) modulation method such as RLL(2,10) or RLL(1,7) is used to record the information data. In the additional information area, a modulation method using only parts of 3T˜11T or 2T˜8T pit or space lengths that appear in the RLL(2,10) modulation and the RLL(1,7) modulation, respectively, are used. A synchronization pattern uses the same pits or spaces in both the user area and the additional information area. The RLL(1,7) modulation uses a synchronization pattern of, for example, a 9T length including pits and spaces, and the RLL(2,10) code uses a synchronization pattern of, for example, a 12T length including pits and spaces. Accordingly, in the additional information area, information is bi-phase modulated by using parts of pits or spaces of 3T˜11T or 2T˜8T length that appear in the RLL(2,10) modulation and the RLL(1,7) modulation, respectively, and then is stored.

In the bi-phase modulation, information is expressed by pits and spaces with nT and 2nT lengths and n is an integer satisfying 2≦n≦5. The reason why the scope of n is limited is that, when the length of a pit or a space used for a synchronization pattern is considered, 2nT should not be longer than a longest pit or space in the synchronization pattern. For example, when the RLL(1,7) modulation is used in the user area, 3T or 6T is used for pits or spaces for bi-phase modulation and 9T is included as a synchronization pattern, in other areas than the user area. However, it is understood that other values of n can be used and other formulae used to determine the run lengths to the extent that the run length does not correspond to a (n±1)T length or otherwise prevent the correction of the run length as explained below.

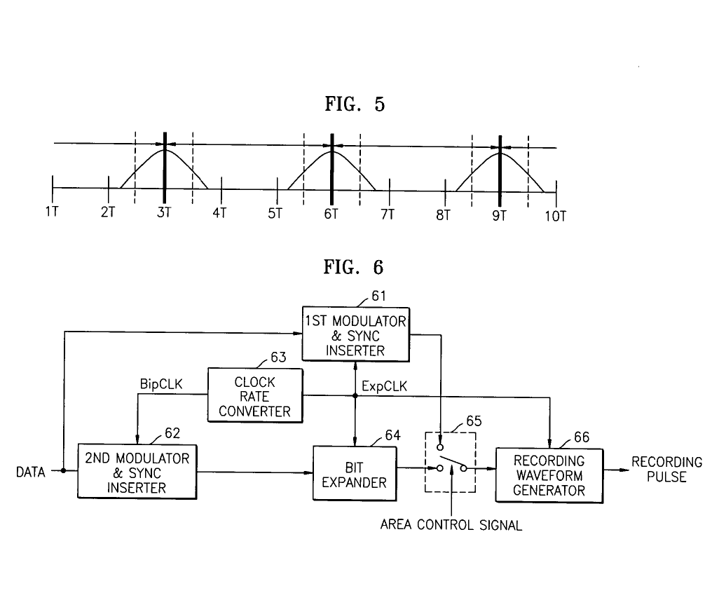

FIG. 5 is a histogram of pits and spaces that are reproduced from the additional information area shown in FIG. 4 after 3T and 6T are used for data modulation and 9T is used for modulation of a synchronization pattern according to the bi-phase modulation. If 3T and 6T are used for data modulation and 9T is used for modulation of a synchronization pattern according to the bi-phase modulation, sometimes pits or spaces with a 3T length may be read as 2T or 4T when data are reproduced, but all the mistakes can be corrected to 3T. Likewise, pits or spaces with a 6T length may be recognized wrongly as 5T or 7T, but all the mistakes can be corrected to 6T. Pits or spaces with a 9T length that are used for the synchronization pattern also can be wrongly read as 8T or 10T, but all the mistakes can be corrected to 9T. The reason is that pits or spaces used in the user information area are used as pits or spaces used in the additional information area other than user area and only 3T, 6T, and 9T are used in the RLL(1,7) modulation. Accordingly, 2T and 4T can be corrected to 3T that is close to the 2T and 4T, 5T and 7T can be corrected to 6T that is close to the 5T and 7T, and 8T and 10T can be corrected to 9T that is close to the 8T and 10T.

As another embodiment, when the RLL(2,10) modulation is used in the user area, pits or spaces for the bi-phase modulation are expressed by 4T and 8T and the synchronization pattern is expressed by 12T. In this embodiment, because of the same reason as the previous embodiment, when data are reproduced, 3T and 5T can be corrected to 4T that is close to the 3T and 5T, 7T, 9T can be corrected to 8T that is close to the 7T and 9T, and 11T and 13T can be corrected to 12T that is close to the 11T and 13T. When information is stored in this manner, the width of a detection window can be extended to more than three times that of the ordinary modulation methods such as the RLL(1,7) and the RLL(2,10) modulation, and accordingly data errors can be reduced.

FIG. 6 is a block diagram of an embodiment of a data recording apparatus according to the present invention. Referring to FIG. 6, according to a modulation clock signal (ExpCLK) generated in a clock rate converter 63, a first modulator & sync inserter 61 performs the RLL(d,k) modulation for data that are being input and to be recorded in the user area, and inserts a synchronization pattern. Examples of the RLL(d,k) modulation include, but are not limited to, the RLL(1,7) modulation or the RLL(2,10) modulation.

Specifically, in the RLL(1,7) modulation, data are recorded as pits and spaces with (2T-8T) lengths and a synchronization pattern of a 9T length formed with pits and spaces is inserted. In the RLL(2,10) modulation, data are recorded as pits and spaces with (3T-11T) lengths and a synchronization pattern of a 2T length formed with pits and spaces is inserted.

According to a bi-phase clock signal (BipCLK) generated in the clock rate converter 63, a second modulator & sync inserter 62 performs bi-phase modulation for information data that are being input and to be recorded in the additional information area, and inserts a synchronization pattern. For example, if the data to be recorded in the user area are modulated by the RLL(1,7) modulation, data to be recorded by bi-phase modulation are expressed by pits and spaces with an nT length or a 2nT length where n satisfies 2≦n≦4, desirably. When n satisfies 2≦n≦4, data formed as pits and spaces with an nT length or a 2nT length are all within the length limit of a pit and a space of the RLL(1,7) modulation. Particularly, if n is set to 3, then 3T and 6T are used for pits or spaces for bi-phase modulation and 9T is included for a synchronization pattern. Likewise, if the data to be recorded in the user area are modulated by the RLL(2,10) modulation, data to be recorded by bi-phase modulation are expressed by pits and spaces with an nT length or a 2nT length where n satisfies 2≦n ≦5, desirably. Particularly, if n is set to 4, 4T and 8T are used for pits or spaces for bi-phase modulation and 12T is included for a synchronization pattern. Thus, when the cycle of a pit and a space by the bi-phase modulation method is used within the scope of the cycle of a pit and space that are used in the user area, there is an advantage that, when data are reproduced, data in both areas can be reproduced by an identical phase locked loop (PLL) circuit according to an aspect of the invention explained below. However, it is understood that multiple PLL circuits can be used instead of using the identical PLL circuit.

The clock rate converter 63 generates a bi-phase clock signal (BibCLK), by frequency dividing the modulation clock signal (ExpCLK), corresponding to the rate of a cycle of a basic clock signal for recording/reproducing data, by a predetermined number (N). The clock rate converter 63 provides the modulation clock signal (ExpCLK) to the first modulator & sync inserter 61, a bit expander 64, and a recording waveform generator 66 and provides the bi-phase clock signal (BipCLK) to the second modulator & sync inserter 62.

According to the modulation clock signal (ExpCLK), the bit expander 64 performs over sampling or zero bit expanding for a modulated bitstream which is output from the second modulator & sync inserter 62. As an example of the over sampling, if the bitstream after the bi-phase modulation is 01010011, this bitstream operates according to a bi-phase clock signal (BipCLK) that is frequency divided into a third (frequency tripled) of a modulation clock signal (ExpCLK). This bitstream is over sampled according to the modulation clock signal (ExpCLK) in which 0 is over sampled into 000 and 1 is over sampled into 111. Then, according to the modulation clock signal (ExpCLK), the bit expander 64 over samples three times the bi-phase modulated bitstream and outputs 000111000111000000111111.

As an example of the zero bit expanding, if the bitstream after the bi-phase modulation is 01001010001, this bitstream operates according to a bi-phase clock signal (BipCLK) that is frequency divided into a third (frequency tripled) of a modulation clock signal (ExpCLK), and this bitstream is zero bit expanded according to the modulation clock signal (ExpCLK) in which 0 is expanded to 000 and 1 is expanded to 100. Then, according to the modulation clock signal (ExpCLK), the bit expander 64 zero bit expands the bi-phase modulated bitstream and outputs 000100000000100000100000000000100.

According to an area control signal which is provided by a system controller (not shown), selector 65 selects a modulated bitstream from the first modulator & sync inserter 61 if the signal indicates a user area, and selects the output stream from the bit expander 64 if the signal indicates an area other than a user area. According to the modulation clock signal (ExpCLK), the recording waveform generator 66 generates a waveform from the bitstream selected by the selector 65, and outputs a recording pulse.

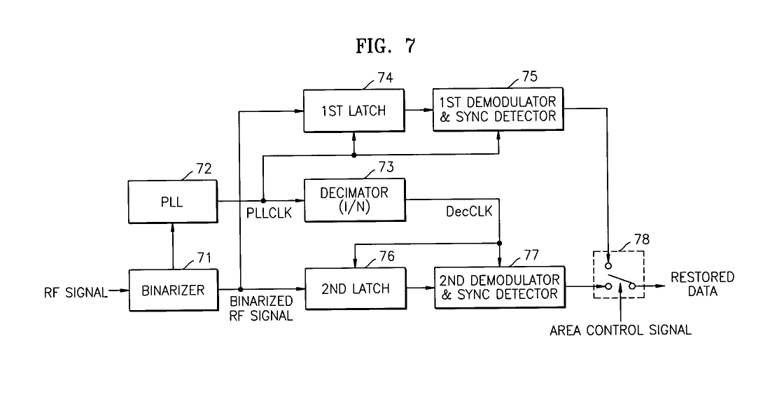

FIG. 7 is a block diagram of an embodiment of a data reproducing apparatus according to the present invention. Referring to FIG. 7, a binarizer 71 binarizes the RF signal reproduced from an information storage medium (i.e., a disc). In order to detect bits by the over sampling or zero bit expanding performed in a recording process, a PLL unit 72 generates a reproduction clock signal (PLLCLK) corresponding to the basic cycle (T) of a recording/reproducing clock signal, and provides the signal (PLLCLK) to a decimator 73, a first latch 74, and a first demodulator & sync detector 75. The decimator 73 generates a clock signal (DecCLK) obtained by reducing the reproduction clock signal (PLLCLK) to 1/N, and provides the signal (DecCLK) to a second latch 76 and a second demodulator & sync detector 77.

The first latch 74 latches the binarized RF signal output from the binarizer 71 according to the reproduction clock signal (PLLCLK). According to the reproduction clock signal (PLLCLK), the first demodulator & sync detector 75 demodulates the data latched in the first latch 74 by a demodulation method corresponding to the modulation method which was used when the data were modulated, and detects a synchronization pattern. According to the the clock signal (DecCLK), the second latch 76 latches the binarized RF signal output from the binarizer 71. According to the clock signal (DecCLK), the second demodulator & sync detector 77 demodulates the data latched in the second latch 76 by a demodulation method corresponding to the modulation method which was used when the data were modulated, and detects a synchronization pattern.

According to an area control signal, the selector provides the restored user data output from the first demodulator & sync detector 76 if the signal indicates a user area, and provides the restored additional information data output from the second demodulator & sync detector 77 if the signal indicates an additional information area other than a user area.

An embodiment in which a pit with an nT length is formed and a pit with an (n±1)T length is not formed in a user information area as well as in an additional information area according to the present invention will now be explained.

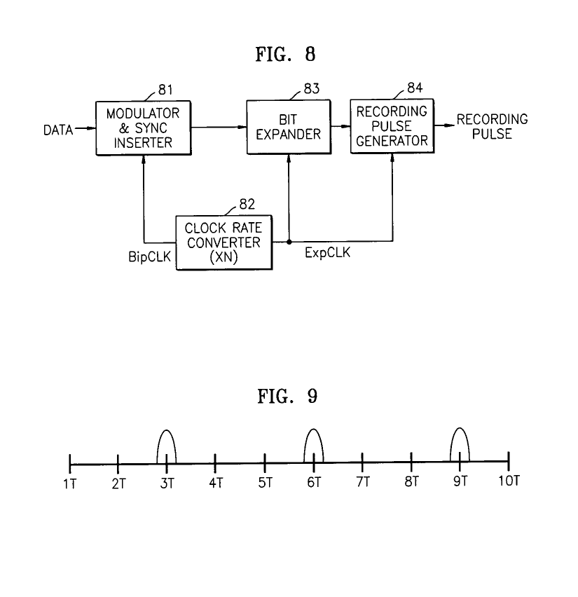

FIG. 8 is a block diagram of another embodiment of a data recording apparatus according to the present invention. Referring to FIG. 8, a modulator & sync inserter 81 modulates information data desired to be recorded on an information storage medium, that is, a disc, and then inserts a synchronization pattern. At this time, a modulation clock signal (BipCLK) is used. A clock rate converter 82 N times frequency multiplies the modulation clock signal (BipCLK) such that a clock signal (ExpCLK), which is N×BipCLK through the frequency multiplication, is generated and provided to a bit expander 83 and a recording pulse generator 84. The clock rate converter 82 may frequency multiply a clock signal, which is used when data are modulated, to make a clock signal to be used in expanding or recording a bitstream, or may frequency divide a clock signal used in expanding or recording a bitstream to make a clock signal to be used when data are modulated according to aspects of the invention.

Here, an example in which a modulated bitstream is over sampled or zero bit expanded according to a frequency multiplied clock signal (ExpCLK) will be explained. As described above, as an example of the over sampling, if the bitstream after the bi-phase modulation is 01010011, this bitstream operates according to a frequency multiplied bi-phase clock signal (BipCLK). If the frequency multiplied clock signal (ExpCLK) is obtained by frequency tripling the modulation clock signal (BipCLK), this bitstream is over sampled according to the frequency multiplied clock signal (ExpCLK) in which 0 is over sampled into 000 and 1 is over sampled into 111. Then, according to the frequency multiplied clock signal (ExpCLK), the bit expander 83 over samples three times the bi-phase modulated bit stream and outputs 000111000111000000111111.

As an example of the zero bit expanding, if when the RLL(1,7) modulation is performed, the bitstream after the bi-phase modulation is 01001010001, this bitstream operates according to a bi-phase clock signal (BipCLK). If the frequency multiplied clock signal (ExpCLK) is obtained by frequency tripling the modulation clock signal (BipCLK), this bitstream is zero bit expanded according to the frequency multiplied clock signal (ExpCLK) in which 0 is expanded to 000 and 1 is expanded to 100. Then, according to the frequency multiplied clock signal (ExpCLK), the bit expander 64 zero bit expands the RLL(1,7) modulated bitstream and outputs 000100000000100000100000000000100.

The recording pulse generator 84 generates a recording pulse from the bitstream provided by the bit expander 83 according to the frequency multiplied clock signal (ExpCLK) so that the bitstream can be finally recorded on the disc.

FIG. 9 is a histogram of data information (pits) recorded by the recording apparatus shown in FIG. 8. The histogram shows that by forming pits with an nT length and not forming pits with an (n±1)T length on a disc, an error that another T begins before a current T ends can be corrected.

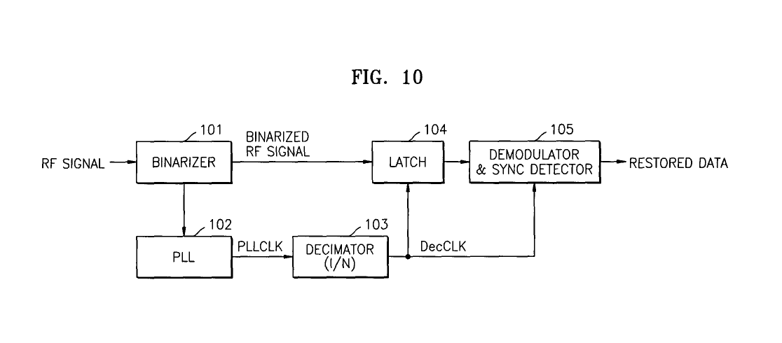

It is preferable, but not required, that information stored on a disc by the recording apparatus described above is reproduced by a data reproducing apparatus as shown in FIG. 10. FIG. 10 is a block diagram of another embodiment of a data reproducing apparatus according to the present invention. Referring to FIG. 10, a binarizer 101 binarizes an RF signal that is reproduced from a disc. In order to detect bits by over sampling or zero bit expanding performed during the data recording process, a reproduction clock signal (PLLCLK) is generated in a PLL circuit 102. A decimator 103 generates a reduced clock signal (DecCLK) by reducing the reproduction clock signal (PLLCLK) to 1/N. A latch 104 latches the binarized RF signal according to the 1/N clock signal (DecCLK). A demodulator & sync detector 105 performs synchronization pattern detection and demodulation by using the latched data and the clock signal (DecCLK) and provided restored information data.

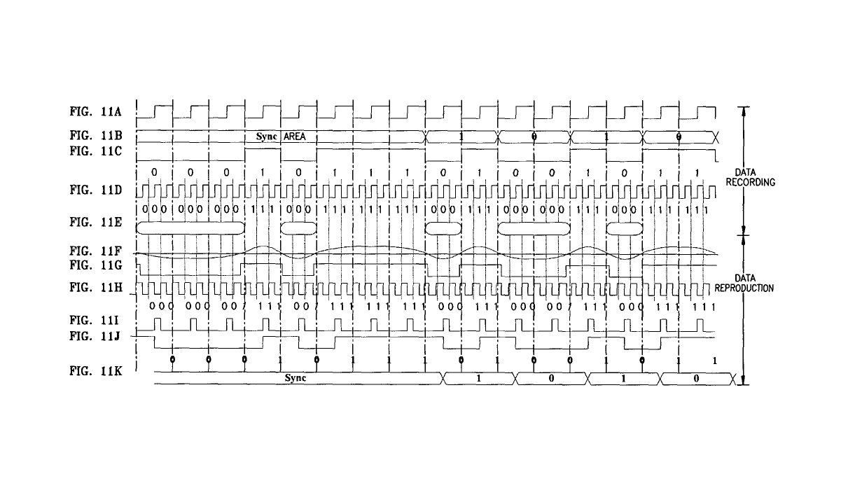

FIGS. 11A through 11K are timing diagrams showing the data recording/reproducing process described referring to FIGS. 8 and 10. FIGS. 11A through 11E show a data recording process and will be explained referring to FIG. 8. FIGS. 11F through 11K show a data reproducing process and will be explained referring to FIG. 10.

FIG. 11A shows the modulation clock signal (BipCLK) provided by the clock rate converter 82. FIG. 11B shows information data which are input to the modulator & sync inserter 81. FIG. 11C shows a modulated stream which is output from the modulator & sync inserter 81 after a synchronization pattern is inserted and modulation is performed. FIG. 11D is the frequency multiplied clock signal (ExpCLK) generated by the clock rate converter 82. FIG. 11E is a bit expanded stream which is output from the bit expander 83.

FIG. 11F shows an RF signal which is input to the binarizer 101. FIG. 11G shows a binarized RF signal which is output from the binarizer 101. FIG. 11H shows a reproduction clock signal (PLLCLK) which is generated in the PLL circuit 102. FIG. 11I shows a clock signal (DecCLK) provided by the decimator 103. FIG. 11J shows the data latched by the latch 104. FIG. 11K shows restored information data which is output from the demodulator & sync detector 105.

As described above, assuming that the cycle of the reproduction clock signal (PLLCLK) is T and there is no error in the reproduced signal, the method for reproducing recorded data, as can be shown from the recording process, is based on the following equation 1:

nT=(m×l)T, l=1,2,3, . . . , and a natural number satisfying m≧3 . . . (1)

A binarized RF signal without an error is, for example, if m=3 and I=1,2, then 3T and 6T. If 2T or 4T comes as a binarized RF signal, the binarized RF signal can be corrected to 3T Similarly, if 5T or 7T comes as a binarized RF signal, the binarized RF signal can be corrected to 6T. By using this characteristic, an RF signal reproduced from a disc on which pits are formed as shown in FIG. 9 can be binarized.

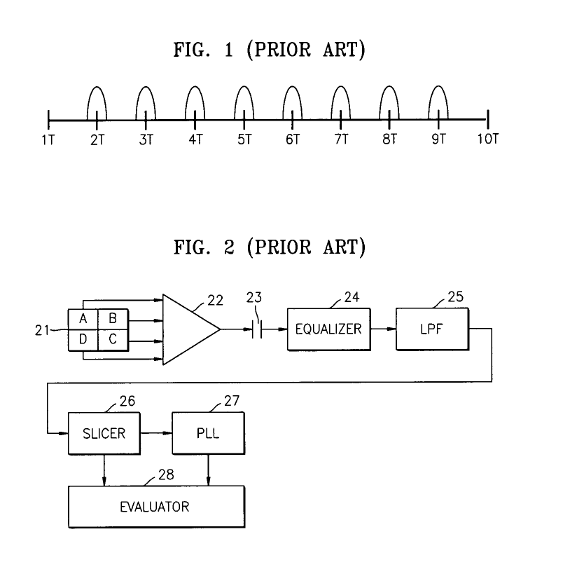

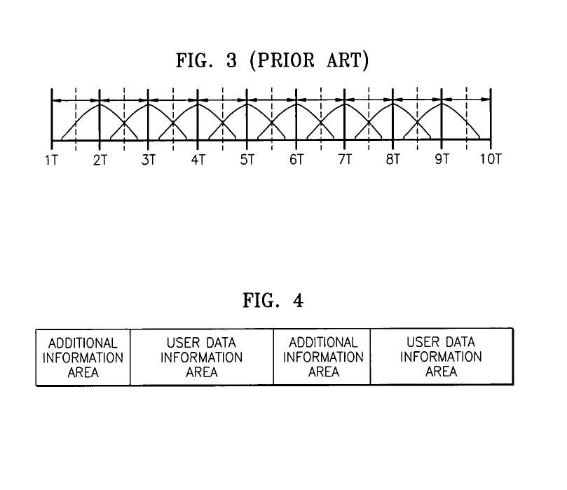

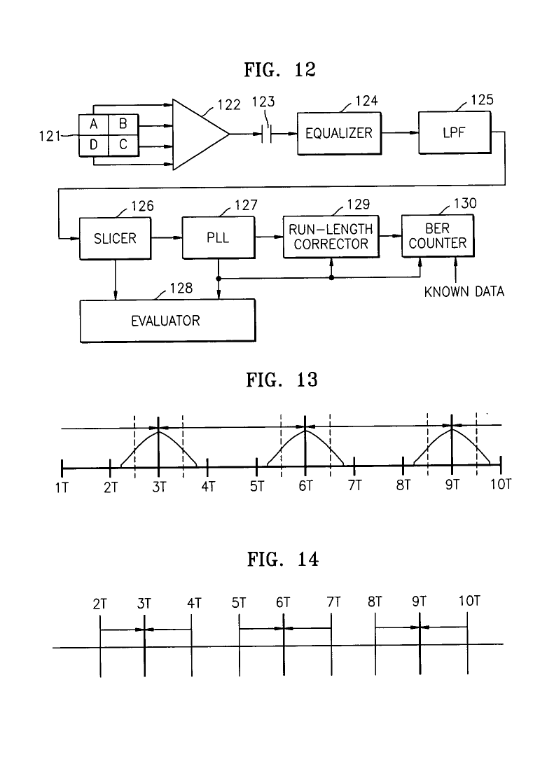

A block diagram of an embodiment of a data evaluating apparatus which evaluates data detection performance by thus binarizing the RF signal is shown in FIG. 12. Compared to the related art data evaluation apparatus shown in FIG. 2, the apparatus of FIG. 12 further comprises a run length corrector 129, a bit error rate or byte error rate (BER) counter 130. As a modified embodiment, the apparatus may be constructed without a reproduction performance evaluator 128 and the BER counter 130, and this construction may be referred to as a data detection apparatus.

Referring to FIG. 12, an optical detector 121 converts an optical signal, which is reflected from a disc, into electrical signals using optical detection parts A, B, C, D. A pre-amplifier 122 adds the electrical signals from the optical detection parts A, B, C, D and provides a high frequency reproduction signal (hereinafter referred to as an “RF signal”). A DC offset remover 123 formed with a capacitor removes the DC offset of the RF signal output from the pre-amplifier 122. An equalizer 124 performs waveform shaping for the RF signal provided by the DC offset remover 123.

A low pass filter (LPF) 125 reduces high frequency noise. A slicer 126 binarizes the analog RF signal into a binary signal. A PLL circuit 127 generates a reproduction clock signal synchronized with the binarized RF signal and provides the clock signal to the evaluator 128, the run length corrector 129, and the BER counter 130. Also, the PLL circuit 127 latches the binarized RF signal.

The evaluator 128 can be implemented as a jitter analyzer or a timing interval analyzer (TIA) according to aspects of the invention. The evaluator 128 receives the binarized RF signal provided by the slicer 126 and the reproduction clock signal generated in the PLL circuit 127 and measures jitter by using the jitter analyzer, or analyzes the histogram of the binarized RF signal by using the TIA, and by doing so, evaluates the quality and performance of a reproduced signal.

The run length corrector 129 corrects the run length of the binarized RF signal which is output from the PLL circuit 127, in which an error of (n±1)T is corrected to nT.

The BER counter 130 receives the reproduction clock signal provided by the PLL circuit 127 and the signal, in which the run length is corrected, provided by the run length corrector 129. By comparing the run length corrected signal with already known information on pits formed on the disc, the BER counter 130 measures an error rate and thus evaluates data detection performance.

FIG. 13 is a histogram of pits observed through the TIA when the pits formed on a disc as shown in FIG. 9 are detected as binarized data and evaluated by the data evaluating apparatus shown in FIG. 12.

When n=3, 6, 9 is used for the present embodiment, errors of (n±1)T such as 2T, 4T, 5T, 7T, 8T, and 10T occur in addition to the original information, that is, 3T, 6T, and 9T. If these errors are corrected from (n±1)T to nT in the run length corrector 129 as the operation principle shown in FIG. 14, 2T and 4T are corrected to 3T, 5T and 7T are corrected to 6T and 8T and 10T are corrected to 9T such that all errors are corrected.

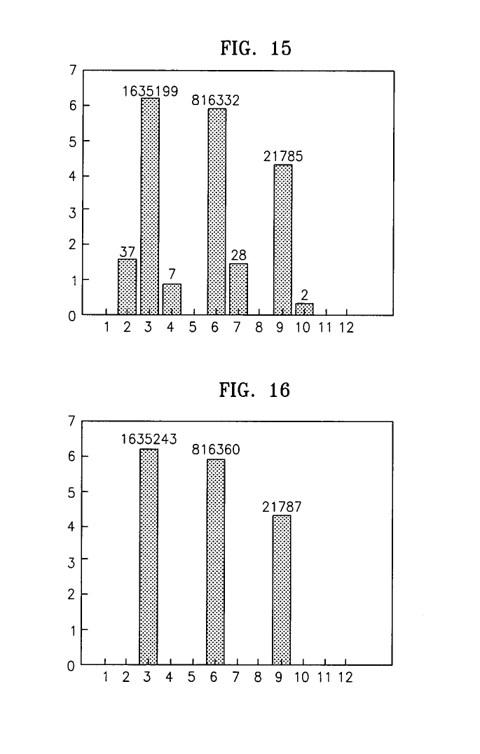

FIG. 15 is a histogram of a binarized RF signal before the signal passes through the run length corrector 129 shown in FIG. 12. FIG. 16 is a histogram of the RF signal corrected by the run length corrector 129 shown in FIG. 12.

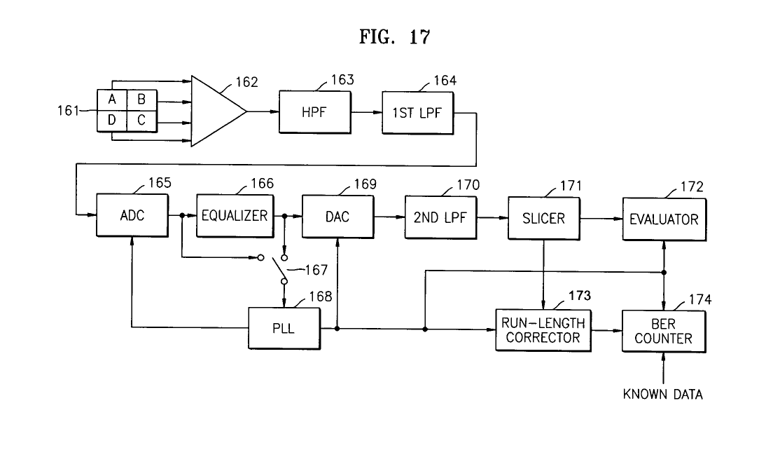

FIG. 17 is a block diagram of another embodiment of a data evaluating apparatus which binarizes the RF signal, which is reproduced from the disc on which pits are formed as shown in FIG. 9, and evaluates the data detection performance. Referring to FIG. 17, an optical detector 161 has optical detection parts A, B, C, D, which convert an optical signal that is reflected from a disc, into electrical signals. A pre-amplifier 162 adds the electrical signals from the optical detection parts A, B, C, D and provides an RF signal. A high pass filter (HPF) 163 removes the DC offset of the RF signal output from the pre-amplifier 162. In order to prevent aliasing, a first LPF 164 low pass filters the RF signal whose DC offset is removed by the HPF 163.

An analog to digital (A/D) converter 165 converts the analog RF signal from the first LPF 164 into digital RF data. An equalizer 166 performs waveform shaping of the digital RF data output from the A/D converter 165.

A PLL circuit 168 generates a clock signal synchronized with the digital RF data output from the A/D converter 165 or the digital RF data from the equalizer 166, by using a switch 167. The PLL circuit 168 provides the clock signal to the A/D converter 165, a digital to analog (D/A) converter 169, a reproduction performance evaluator 172, a run length corrector 173, and a BER counter 174 that need the reproduction clock signal. Here, the switch 167 indicates that the reproduction clock signal may be generated in the PLL circuit 168 by using the output of the A/D converter 165 or the output of the equalizer 166 only by the designer's intention.

The D/A converter 169 converts the digital RF data, which are waveform shaped through the equalizer 166, into an analog signal. A second LPF 170 removes quantization noise included in the output signal of the D/A converter 169.

In order to detect information reproduced from the disc, a slicer 171 binarizes the output of the second LPF 170 as 0 or 1. The run length corrector 173 corrects the run length of binarized data output from the slicer 171, in which an error of (n±1)T occurring in the signal is corrected to nT. The BER counter 174 receives the reproduction clock signal from the PLL circuit 168 and run length corrected data from the run length corrector 173, and by comparing the run length correct data with already known information on the pits formed on the disc, measures an error rate. Data detection performance is evaluated by the BER counter 174. Also, the evaluator 172 formed with a jitter detector or a TIA evaluates the quality of the binarized RF signal provided by the slicer 171.

An alternative unit such as a partial response maximum likelihood (PRML) circuit can be used instead of the slicer 126 and 171 shown in FIGS. 12 and 17.

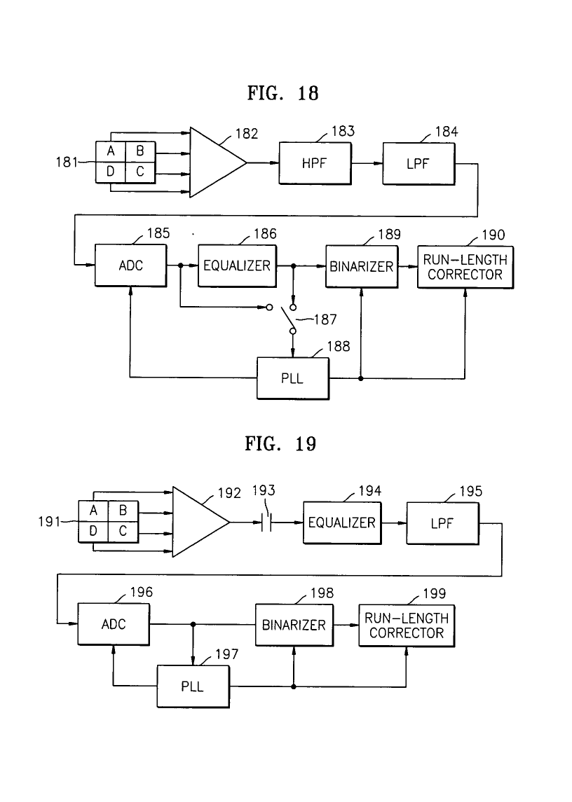

FIG. 18 is a block diagram of an embodiment of a data detection apparatus which detects data when information data formed as shown in FIG. 9 are reproduced from the disc. Referring to FIG. 18, an optical detector 181 has optical detection parts A, B, C, D, which convert an optical signal, which is reflected from a disc, into electrical signals. A pre-amplifier 182 adds the electrical signals from the optical detection parts A, B, C, D and provides an RF signal. An HPF 183 removes the DC offset of the RF signal output from the pre-amplifier 182. In order to prevent aliasing, an LPF 184 low pass filters the RF signal whose DC offset is removed by the HPF 183.

An A/D converter 185 converts the analog RF signal from the LPF 184 into digital RF data. An equalizer 186 performs waveform shaping of the digital RF data output from the A/D converter 185. A PLL circuit 188 generates a clock signal synchronized with the digital RF data output from the A/D converter 185 or the digital RF data from the equalizer 186, by using a switch 187, and provides the clock signal to the A/D converter 185, a binarizer 189, and a run length corrector 190 that need the reproduction clock signal.

The binarizer 189 converts the output of the equalizer 186 into binary values and provides the binarized RF signal. This binarizer 189 may indicate any of available units such as a slicer circuit (i.e., a slicer) and a PRML circuit. The run length corrector 190 corrects the run length of the binarized RF signal output from the binarizer 189, in which an error of (n±1)T occurring in the signal is corrected to nT.

FIG. 19 is a block diagram of another embodiment of a data detection apparatus which detects data when information data formed as shown in FIG. 9 are reproduced from the disc. Referring to FIG. 19, an optical detector 191 has optical detection parts A, B, C, D which convert an optical signal, which is reflected from a disc, into electrical signals. A pre-amplifier 192 adds the electrical signals from the optical detection parts A, B, C, D and provides an RF signal. A DC offset remover 193 removes the DC offset of the RF signal output from the pre-amplifier 192. An equalizer 194 performs waveform shaping for the RF signal from the DC offset remover 193. An LPF 195 low pass filters the output of the equalizer 194 such that aliasing can be prevented.

An A/D converter 196 converts the analog RF signal from the LPF 195 into digital RF data. A PLL circuit 197 generates a clock signal synchronized with the digital RF data output from the A/D converter 196, and provides the clock signal to the A/D converter 196, a binarizer 198, and a run length corrector 199 that need the reproduction clock signal.

The binarizer 198 converts the output of the A/D converter 196 into binary values and provides the binarized RF signal. The run length corrector 199 corrects the run length of the binarized RF signal output from the binarizer 198, in which an error of (n±1)T occurring in the signal is corrected to nT.

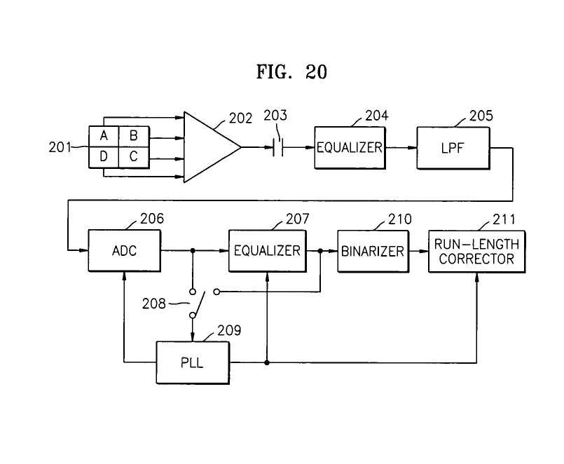

FIG. 20 is a block diagram of still another embodiment of a data detection apparatus when information data formed as shown in FIG. 9 are reproduced from the disc. Referring to FIG. 20, an optical detector 201 converts an optical signal, which is reflected from a disc, into an electrical signal. A pre-amplifier 202 adds electrical signals from all optical detection parts (A, B, C, D) and provides an RF signal. A DC offset remover 203 removes the DC offset of the RF signal output from the pre-amplifier 202. An equalizer 204 performs waveform shaping for the RF signal from the DC offset remover 203. An LPF 205 low pass filters the output of the equalizer 204 such that aliasing can be prevented. An A/D converter 206 converts the analog RF signal from the LPF 205 into digital RF data. An equalizer 207 performs waveform shaping of the digital RF data output from the A/D converter 206. A PLL circuit 209 generates a clock signal synchronized with the digital RF data output from the A/D converter 206 or the digital RF data from the equalizer 207, by using a switch 208, and provides the clock signal to the A/D converter 206, the equalizer 207, the binarizer 210, and a run length corrector 211 that need the reproduction clock signal.

The binarizer 210 converts the output of the equalizer 207 into binary values and provides the binarized RF signal. The run length corrector 211 corrects the run length of the binarized RF signal output from the binarizer 210, in which an error of (n±1)T occurring in the signal is corrected to nT.

According to the present invention as described above, by using different modulation methods in the user area and in the remaining areas, the width of the data detection window is extended such that stable reproduction of data is enabled. Since only parts of pits or spaces in the user area are used in the additional information area according to the present invention, there is a shared circuit (the PLL circuit) and the hardware requirement of the reproducing apparatus can be reduced. Further, by forming pits with an nT length and not forming pits with an (n±1)T length according to the present invention, correction of a signal is enabled such that an error that another T begins before a current T ends can be corrected and stable reproduction of data is enabled.

It is understood that one of more of the features of the present invention can be implemented using computer software encoded on a computer readable medium to for use with a computer to perform the method of the invention. Such computer software can include firmware, and the computer can be a special or general purpose computer.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium comprising pits to record information data, wherein the information data are modulated by a predetermined modulation method, bit expansion is performed for the modulated bitstream, and the expanded bitstream is recorded on the information storage medium such that the information data comprise pits with an nT length and do not comprise pits with an (n±1)T length, where the T is the cycle of a basic clock signal for recording or reproducing data and n is an integer.

2. The information storage medium of claim 1, wherein the predetermined modulation method is an RLL(d,k) modulation method.

3. The information storage medium of claim 1, wherein the predetermined modulation method is a bi-phase modulation method.

4. The information storage medium of claim 1, wherein the information data are modulated according to a first clock signal having the cycle of the basic clock signal, and the modulated bitstream is bit expanded according to a second clock signal which is a predetermined multiple of the first clock signal.

5. An information storage medium comprising:
a first area which stores data modulated by a first modulation method; and
a second area which stores data modulated by a second modulation method,
wherein the data modulated by the second modulation method are stored by using only parts of pits or spaces formed on the storage medium by the first modulation method.

6. The information storage medium of claim 5, wherein the first area is an area in which user data are stored.

7. The information storage medium of claim 5, wherein the second area is one of an additional information area, a data link block, and a run in/out area.

8. The information storage medium of claim 7, wherein the additional information includes one of copyright protection related information, disc manufacturer related information, contents provider related information, contents right related information, contents specification related information, and additional information for correcting errors in user data.

9. The information storage medium of claim 5, wherein the first modulation method is an RLL(d,k) modulation method satisfying a minimum constraint d and a maximum constraint k.

10. The information storage medium of claim 5, wherein the second modulation method is a bi-phase modulation method.

11. The information storage medium of claim 5, wherein:
the first modulation method is an RLL(1,7) modulation method satisfying a minimum constraint 1 and a maximum constraint 7,
a pit or a space is formed as 2T˜8T, and
T denotes the cycle of a basic clock signal for recording or reproducing data.

12. The information storage medium of claim 11, further comprising a synchronization pattern of 9T formed with a pit or a space.

13. The information storage medium of claim 5, wherein:
the second modulation method is a bi-phase modulation,
a pit or a space is formed as nT and 2nT,
n is an integer satisfying 2≦n≦4, and
T denotes the cycle of a basic clock signal for recording or reproducing data.

14. The information storage medium of claim 13, wherein n is 3 and a pit or a space is 3T or 6T.

15. The information storage medium of claim 14, further comprising a synchronization pattern of 9T formed with a pit or a space.

16. The information storage medium of claim 5, wherein:
the first modulation method is an RLL(2,10) modulation method,
a pit or a space is formed as 3T˜11T, and
T denotes the cycle of a basic clock signal for recording or reproducing data.

17. The information storage medium of claim 16, further comprising a synchronization pattern of 12T formed with a pit or a space.

18. The information storage medium of claim 5, wherein:
the second modulation method is a bi-phase modulation,
a pit or a space is formed as nT and 2nT,
n is an integer satisfying 3≦n≦5, and
T denotes the cycle of a basic clock signal for recording or reproducing data.

19. The information storage medium of claim 18, wherein:
n is 4, and
the pit or the space is 4T or 8T.

20. The information storage medium of claim 19, further comprising a synchronization pattern of 12T formed with a pit or a space.

21. A data recording apparatus which records information data on an information storage medium, comprising:
a modulation unit which modulates input information data by a predetermined modulation method according to a first clock signal having a basic clock period for recording or reproducing data to form a modulated bitstream; and
a bit expander which expands bits of the modulated bitstream according to a second clock signal which is a predetermined multiple of the first clock signal so as to form an adjusted modulated bitstream to be recorded as pits with an nT length,
wherein T is the basic clock period and n is an integer.

22. The apparatus of claim 21, wherein the modulation unit modulates the information data by an RLL(d,k) modulation method satisfying a minimum constraint d and a maximum constraint k and inserts a synchronization pattern into the modulated bitstream.

23. The apparatus of claim 21, wherein the modulation unit modulates the information data by a bi-phase modulation method and inserts a synchronization pattern into the modulated bitstream.

24. The apparatus of claim 21, further comprising:
a clock rate converter which frequency multiplies the first clock signal used in the modulation unit to generate a second clock signal to be used in expanding and/or recording the bitstream.

25. The apparatus of claim 21, further comprising:
a clock rate converter which frequency divides the second clock signal used in expanding and/or recording the bitstream to generate the first clock signal used in the modulation unit.

26. The apparatus of claim 21, wherein the bit expander performs one of over sampling and zero bit expanding for the modulated bitstream which is output from the modulation unit according to the second clock signal.

27. A data recording apparatus which records information data on an information storage medium having at least a first area and a second area other than the first area, the apparatus comprising:
a first modulation unit which modulates input information data according to a first modulation method to produce first modulated data;
a second modulation unit which modulates the input information data according to a second modulation method to produce second modulated data; and
a recording unit which records the first modulated data as pits or spaces in the first area and records the second modulated data as pits or spaces in the second area,
wherein the second modulated data uses only parts of pits or spaces formed on the information storage medium by the first modulation method.

28. The apparatus of claim 27, wherein the first modulation unit comprises a first modulator & sync inserter which modulates the input information data by an RLL(d,k) modulation method satisfying a minimum constraint d and a maximum constraint k and inserts a synchronization pattern.

29. The apparatus of claim 28, wherein the second modulation unit comprises:
a second modulator & sync inserter which bi-phase modulates the information data and inserts a longest pit or space used as the synchronization pattern inserted by the first modulator & sync inserter as the synchronization pattern to output a modulated bit stream; and
a bit expander which bit expands the modulated bitstream output from the second modulator & sync inserter.

30. The apparatus of claim 29, further comprising:
a clock rate converter which generates a modulation clock signal which has the cycle of a basic clock signal for recording or reproducing data and is used in the first modulator & sync inserter and the bit expander, and frequency divides the modulation clock signal and provides the frequency divided clock signal to the second modulator & sync inserter.

31. The apparatus of claim 30, wherein the bit expander performs over sampling or zero bit expanding for the modulated bitstream output from the second modulator & sync inserter according to the modulation clock signal.

32. A data reproducing apparatus which reproduces information data stored on an information storage medium, the apparatus comprising:
a clock generation unit which generates a first clock signal synchronized with a reproduction signal which is reproduced from the information storage medium and generates a second clock signal obtained by reducing the first clock signal by a predetermined number; and
a restoration unit which restores the reproduction signal by a demodulation method corresponding to a modulation method used in recording the signal according to the second clock signal to provide restored information data.

33. The apparatus of claim 32, further comprising:
a binarizing unit which binarizes the reproduction signal read from the information storage medium, and provides the binarized reproduction signal to the clock generation unit and the restoration unit.

34. The apparatus of claim 32, wherein the clock generation unit comprises:
a phase locked loop (PLL) circuit which generates a reproduction clock signal from the binarized reproduction signal; and
a decimator which reduces the reproduction clock signal by the predetermined number.

35. A data reproduction apparatus which reproduces data stored on an information storage medium having at least a first area including first modulated data modulated by a first modulation method and a second area other than the first area and which includes second modulated data modulated by a second modulation method, the apparatus comprising:
a binarizing unit which binarizes a reproduction signal read from the information storage medium and provides a binarized reproduction signal;
a clock generation unit which generates a reproduction clock signal from the binarized reproduction signal and generates a reduced clock signal obtained by reducing the reproduction clock signal by a predetermined number;
a first restoration unit which restores the binarized reproduction signal by a first demodulation method corresponding to the first modulation method according to the reproduction clock signal so as to reproduce the first modulated data; and
a second restoration unit which restores the binarized reproduction signal by a second demodulation method corresponding to the second modulation method according to the reduced clock signal so as to reproduce the second modulated data.

36. The apparatus of claim 35, wherein the clock generation unit comprises:
a phase locked loop (PLL) circuit which generates the reproduction clock signal from the binarized reproduction signal; and
a decimator which reduces the reproduction clock signal by the predetermined number to generated the reduced clock signal.

37. The apparatus of claim 35, further comprising:
a selection unit which selects the output of the first restoration unit if an area control signal indicates that the binarized reproduction signal is from the first area including a user area, and selects the output of the second restoration unit if the area control signal indicates that the binarized reproduction signal is from the second area including a remaining area.

38. A data detection apparatus which detects data on an information storage medium including information data with an nT length, the apparatus comprising:
a converting unit which converts an optical signal read from the information storage medium into a reproduction signal;
a binarizing unit which binarizes the reproduction signal and provides a binarized signal; and
a correction unit which corrects a run length of the binarized signal,
wherein T denotes a cycle of a basic clock signal for recording or reproducing data and n is an integer.

39. The apparatus of claim 38, wherein the correction unit corrects the binarized signal having an error of the run length of (n±1)T to a corrected run length of nT.

40. The apparatus of claim 38, further comprising:
a clock generation unit which generates a reproduction clock signal synchronized with the reproduction signal and provides the clock signal to the binarizing unit and the correction unit.

41. The apparatus of claim 38, wherein the converting unit comprises:
an optical detector having optical detection parts which convert the optical signal into electrical signals; and
a pre-amplifier which adds the electrical signals to provide the reproduction signal.

42. The apparatus of claim 38, further comprising:
a waveform shaping unit which waveform shapes the reproduction signal and provides a waveform-shaped reproduction signal for use in the binarizing unit.

43. The apparatus of claim 42, further comprising:
a quantization unit which quantizes the waveform-shaped reproduction signal and provides a quantized reproduction signal for use in the binarizing unit.

44. The apparatus of claim 43, further comprising:
a clock generation unit which generates a reproduction clock signal synchronized with the quantized reproduction signal and provides the reproduction clock signal to the quantization unit, the binarizing unit, and the correction unit.

45. The apparatus of claim 43, further comprising:
an equalizer which waveform shapes the output of the quantization unit and provides an equalized reproduction signal for use in the binarizing unit.

46. The apparatus of claim 45, further comprising:
a clock generation unit which generates a reproduction clock signal synchronized with the equalized reproduction signal and provides the reproduction clock signal to the equalizer, the binarizing unit, and the correction unit.

47. The apparatus of claim 42, wherein the waveform shaping unit comprises:
a direct current (DC) offset remover which removes a DC offset included in the reproduction signal to provide an offset reproduction signal;
an equalizer which shapes a waveform of the offset reproduction signal to provide an equalized reproduction signal; and
a low pass filter which low pass filters the equalized reproduction signal to produce the waveform-shaped reproduction signal.

48. The apparatus of claim 42, wherein the waveform shaping unit comprises:
a high pass filter which removes a DC offset included in the reproduction signal to provide an offset reproduction signal; and
a low pass filter which low pass filters the output of the high pass filter to produce the waveform-shaped reproduction signal.

49. The apparatus of claim 38, wherein the binarizing unit comprises a slicer circuit to provide the binarized signal.

50. The apparatus of claim 38, wherein the binarizing unit comprises a partial response maximum likelihood (PRML) circuit to provide the binarized signal.

51. A data evaluating apparatus which detects and evaluates data on an information storage medium which includes information data with an nT length, the apparatus comprising:
a converting unit which converts an optical signal read from the information storage medium into a reproduction signal;
a binarizing unit which binarizes the reproduction signal and provides a binarized signal;
a correction unit which corrects a run length of the binarized signal; and
an error rate detection unit which counts an error rate for the output of the correction unit and evaluates the performance of data detection,
wherein T denotes a cycle of a basic clock signal for recording or reproducing data and n is an integer.

52. The apparatus of claim 51, wherein the correction unit corrects the run length of the binarized signal having an error of (n±1)T to a corrected run length of nT.

53. The apparatus of claim 51, further comprising:
a clock generation unit which generates a reproduction clock signal synchronized with the reproduction signal and provides the clock signal to the binarizing unit and the correction unit.

54. The apparatus of claim 53, further comprising:
an evaluating unit which evaluates a quality of the binarized signal according to the reproduction clock signal.

55. The apparatus of claim 51, wherein the converting unit comprises:
an optical detector having optical detection parts which convert the optical signal into electrical signals; and
a pre-amplifier which adds the electrical signals to provide the reproduction signal.

56. The apparatus of claim 51, further comprising:
a waveform shaping unit which waveform shapes the reproduction signal to provide a waveform-shaped reproduction signal for use in the binarizing unit.

57. The apparatus of claim 56, further comprising:
a quantization unit which quantizes the waveform-shaped reproduction signal to provide a quantized reproduction signal.

58. The apparatus of claim 57, further comprising:
a clock generation unit which generates a reproduction clock signal synchronized with the quantized reproduction signal and provides the reproduction clock signal to the quantization unit, the binarizing unit, and the correction unit.

59. The apparatus of claim 57, further comprising:
an equalizer which waveform shapes the output of the quantization unit to provide an equalized reproduction signal for use in the binarizing unit.

60. The apparatus of claim 59, further comprising:
a digital to analog (D/A) converter which converts the equalized reproduction signal to an analog signal;
a low pass filter which low pass filters the analog signal to provide a low pass filtered analog signal; and
an evaluating unit which evaluates the quality of the binarized signal according to a reproduction clock signal.

61. The apparatus of claim 60, further comprising:
a clock generation unit which generates the reproduction clock signal synchronized with the output signal of the equalizer and provides the reproduction clock signal to the equalizer, the D/A converter, the binarizing unit, and the correction unit.

62. The apparatus of claim 56, wherein the waveform shaping unit comprises:
a direct current (DC) offset remover which removes a DC offset included in the reproduction signal to provide an offset reproduction signal;
an equalizer which shapes a waveform of the offset reproduction signal; and
a low pass filter which low pass filters the output of the equalizer to provide a waveform-shaped reproduction signal.

63. The apparatus of claim 56, wherein the waveform shaping unit comprises:
a high pass filter which removes a DC offset included in the reproduction signal to provide an offset reproduction signal; and
a low pass filter which low pass filters the offset reproduction signal to provide a waveform-shaped reproduction signal.

64. The apparatus of claim 51, wherein the binarizing unit comprises a slicer to provide the binarized signal.

65. The apparatus of claim 51, wherein the binarizing unit comprises a partial response maximum likelihood (PRML) circuit to provide the binarized signal.

66. A data recording method by which information data are recorded on an information storage medium, the method comprising:
modulating input information data by a predetermined modulation method according to a first clock signal having a basic clock period for recording or reproducing data and providing a modulated bitstream; and
providing an expanded bitstream by bit expanding the modulated bitstream according to a second clock signal which is a predetermined multiple of the first clock signal in order to form the modulated bitstream to be recorded on the information storage medium as pits with an nT length,
wherein T is the basic clock period and n is an integer.

67. A data recording method for recording information data on an information storage medium having at least a first area and a second area other than the first area, the method comprising:
modulating input information data according to a first modulation method to produce first modulated data;
modulating the input information data according to a second modulation method to produce second modulated data; and
recording the first modulated data as pits or spaces in the first area and recording the second modulated data as pits or spaces in the second area,
wherein the second modulated data uses only parts of the pits or spaces formed on the information storage medium by the first modulation method.

68. The method of claim 67, wherein the modulating the input information data by the first modulation method comprises modulating the input information data by an RLL(d,k) modulation method satisfying a minimum constraint d and a maximum constraint k according to a modulation clock signal having a cycle of a basic clock signal for recording or reproducing data and inserting a synchronization pattern to produce the first modulated data.

69. The method of claim 68, wherein the modulating the input information data by the second modulation method comprises:
bi-phase modulating the input information data according to a clock signal obtained by frequency dividing the modulation clock signal, and inserting a longest pit or space used as the synchronization pattern as the synchronization pattern to produce a modulated bitstream data; and
bit expanding the modulated bitstream to produce the second modulated data.

70. The method of claim 69, wherein the bit expanding the modulated bitstream comprises selecting between over sampling and zero bit expanding the modulated bitstream according to the modulation clock signal.

71. A data reproducing method by which information data stored on an information storage medium are reproduced, the method comprising:
generating a first clock signal synchronized with a reproduction signal which is reproduced from the information storage medium and generating a second clock signal obtained by reducing the first clock signal by a predetermined number; and
providing restored information data by restoring the reproduction signal according to the second clock signal by a demodulation method corresponding to a modulation method used when the information data was recorded on the information storage medium.

72. A data reproduction method of reproducing information data stored on an information storage medium having at least a first area storing first modulated data modulated by a first modulation method and a second area other than the first area and having second modulated data modulated by a second modulation method, the method comprising:
binarizing a reproduction signal read from the information storage medium and providing a binarized reproduction signal;
restoring the binarized reproduction signal according to a reproduction clock signal by a first demodulation method corresponding to the first modulation method; and
restoring the binarized reproduction signal according to a clock signal obtained by reducing the reproduction clock signal to 1/N by a second demodulation method corresponding to the second modulation method,
wherein N is a predetermined number.

73. The method of claim 72, further comprising:
generating the reproduction clock signal from the binarized reproduction signal and generating the clock signal obtained by reducing the reproduction clock signal by the predetermined number.

74. A data detection method of detecting information data on an information storage medium, the information data having an nT length, the method comprising:
binarizing a reproduction signal reproduced from the information storage medium and providing a binarized signal; and
correcting a run length of the binarized signal,
wherein T denotes a cycle of a basic clock signal for recording or reproducing data and n is an integer.

75. The method of claim 74, wherein the correcting the run length comprises correcting the binarized signal having an error of the run length of (n±1)T to a corrected run length of nT.

76. A data evaluating method of detecting and evaluating information data on an information storage medium which includes the information data with an nT length, the method comprising:
binarizing a reproduction signal reproduced from the information storage medium and providing a binarized signal;
correcting a run length of the binarized signal and providing a corrected signal; and
counting an error rate of the corrected signal and evaluating the performance of data detection,
wherein T denotes a cycle of a basic clock signal for recording or reproducing data and n is an integer.

77. The method of claim 76, wherein the correcting the run length comprises correcting the binarized signal having an error of the run length of (n±1)T to a corrected run length of nT.

78. The data recording apparatus of claim 21, further comprising a recording unit which records the adjusted modulated bitstream on the information storage medium.

79. An information storage medium comprising pits having run lengths to record information data, wherein:
the information data are recorded by:
determining run lengths for the pits to be formed to have an nT run length but not to have an (n±1)T run length, and
recording the information data as the pits using the determined nT run length so as to not form pits having the run length of (n±1)T,
T is a cycle of a basic clock signal for recording or reproducing data, and
n is an integer.

80. The information storage medium of claim 79, further comprising a first area and a second area other than the first area, wherein:
one portion of the information data is recorded in the first area are recorded using a first modulation method,
another portion of the information data recorded in the second area are recorded using a second modulation method other than the first modulation method.
